(19) United States
(12) Patent Application Publication
(10) Pub. No.: US 2013/0033851 A1
(43) Pub. Date: Feb. 7, 2013

(54) AQUARIUM LED LIGHTING DEVICE

(71) Applicant: Yu-Chin WANG, Taipei (TW)

(72) Inventor: Yu-Chin WANG, Taipei (TW)

(21) Appl. No.: 13/204,689

(22) Filed: Aug. 7, 2011

(51) Int. Cl. F21V 33/00

(52) U.S. Cl. 362/101

(57) ABSTRACT

An aquarium LED lighting device includes a casing defining two opposing locating grooves and a recessed accommodation portion between the locating grooves. a LED circuit board mounted in the recessed accommodation portion of the casing and carrying a plurality of LEDs at the light-emitting side thereof, a LED cover board affixed to the casing and having integrated LED caps respectively disposed corresponding to the LEDs of the LED circuit board for disusing the light emitted by the LEDs. each LED cap defining therein a recessed hole for receiving one respective LED, two packing strips respectively fastened to the locating grooves of the casing to secure the LED cover board to the casing, and two end blocks respectively fastened to the casing to close the two distal ends of the casing.

### BACKGROUND OF THE INVENTION

1. Field of the Invention

The present invention relates to lighting technology and more particularly, to an aquarium LED lighting device, which has a flat configuration and is easy to mount and to dismount.

2. Description of the Related Art

An aquarium needs to be equipped with a lighting device at the top side to provide illumination for viewing at night. An early design of lighting device for aquarium generally comprises a fluorescent lamp tube and a lampshade surrounding the upper side of the fluorescent lamp tube. In recent years, due to fast development of LED fabrication technology, many LED lighting devices have been created for use in an aquarium. Taiwan Patent M347827 discloses a similar design, entitled “Aquarium LED lighting apparatus”.

As the light emitted by a LED lamp is directional, a LED lighting device for aquarium must have a reflector be obliquely mounted in the lampshade thereof to reflect the emitted light toward the desired illumination area. However, the use of the reflector greatly increases the height of the LED lighting device. To improve this drawback, a flat type LED lighting device for aquarium, as illustrated in FIGS. 1 and 2, is disclosed. According to this design, the flat type LED lighting device comprises a lamp case 91, a LED circuit board 92 mounted in the lamp case 91, a cover board 93 fastened to the front side of the lamp case 91, and a plurality of LED caps 94 respectively mounted in respective conical holes in the cover board 93. Each LED cap 94 defines a recessed hole 941 for receiving one respective LED, as illustrated in FIG. 2. By means of the LED caps 94, the light emitted by each LED of the LED circuit board 92 is diffused. This design of flat type LED lighting device has low-profile characteristic.

However, during installation of the prior art design shown in FIGS. 1 and 2, the cover board 93 must be fastened to the front side of the lamp case 91 at first, so that the LED caps 94 can be inserted into the respective conical holes in the cover board 93 one after another. This installation procedure wastes much time and labor. When inserting the LED caps 94 into the respective conical holes in the cover board 93, the LEDs may be damaged accidentally.

Further, when any individual LED fails after a long use and must be replaced by a new one, the LED caps 94 must be removed from the respective conical holes in the cover board 93 before detaching the cover board 93 from the lamp case 91, complicating maintenance and repair works. Further, during dismounting, the LEDs may be damaged accidentally.

### SUMMARY OF THE INVENTION

The present invention has been accomplished under the circumstances in view. It is the main object of the present invention to provide an aquarium LED lighting device, which eliminates the drawbacks of the aforesaid prior art design.

To achieve this and other objects of the present invention, an aquarium LED lighting device comprises a casing, which comprises two locating grooves respectively extending along opposing front and rear sides thereof in a parallel manner and a recessed accommodation portion defined between the two locating grooves, a LED circuit board, which is mounted in the recessed accommodation portion of the casing and comprises a plurality of light-emitting diodes arranged the light-emitting side thereof, a LED cover board, which is affixed to the casing and kept in a parallel manner relative to the LED circuit board and comprises a plurality of LED caps respectively disposed corresponding to the light-emitting diodes of the LED circuit board and adapted for disusing the light emitted by the light-emitting diodes, each LED cap defining therein a recessed hole for receiving one respective light-emitting diode, two packing strips respectively fastened to the locating grooves of the casing to secure the LED cover board to the casing, and two end blocks respectively fastened to the casing to close the two distal ends of the casing.

When assembling the aquarium LED lighting device, affix the LED circuit board to the e recessed accommodation portion of the casing by screws 2, and then attach the LED cover board to the recessed accommodation portion of the casing in a vertical direction, and then insert the packing strips into the locating grooves of the casing in a horizontal direction to let the opposing front and rear edges of the LED cover board be respectively sandwiched in between flat horizontal bases of the packing strips and elongated horizontal planes of the casing, and then attach the two end blocks to the casing to close the two distal ends of the casing, and thus, the aquarium LED lighting device is assembled. In case any individual LED of the LED circuit board fails, reverse the aforesaid assembling procedure to detach the LED cover board from the casing, exposing the LEDs of the LED circuit board for replacement.

Obviously, the invention has advantages over the prior art design as follows:

1. The whole structure is easy to assemble.

2. The whole assembly is easily detachable, facilitating replacement of individual LEDs.

3. During the assembling process, the LED cover board is vertically attached to the casing to directly approach the recessed holes of the respective LED caps of the LED cover board to the respective LEDs, avoiding accidental image damage.

4. The invention utilizes the conical LED caps to diffuse the light emitted by the LEDs, providing uniform illumination and enabling the height of the lighting device to be minimized.

### BRIEF DESCRIPTION OF THE DRAWINGS

FIG. 1 is an exploded view of an aquarium lighting device according to the prior art.

FIG. 2 is a sectional assembly view of the aquarium lighting device according to the prior art.

FIG. 3 is an exploded view of an aquarium LED lighting device according to the present invention.

FIG. 3A is an enlarged view of part A of FIG. 3.

FIG. 4 is an elevational assembly view of the aquarium LED lighting device according to the present invention.

FIG. 5 is a sectional view of the aquarium LED lighting device according to the present invention.

FIG. 5A is an enlarged view of part A of FIG. 5.

FIG. 6 is a schematic drawing illustrating an assembly operation of the aquarium LED lighting device in accordance with the present invention.

FIG. 7 is a schematic drawing of the present invention, illustrating the LED cover board perpendicularly fastened to the casing.

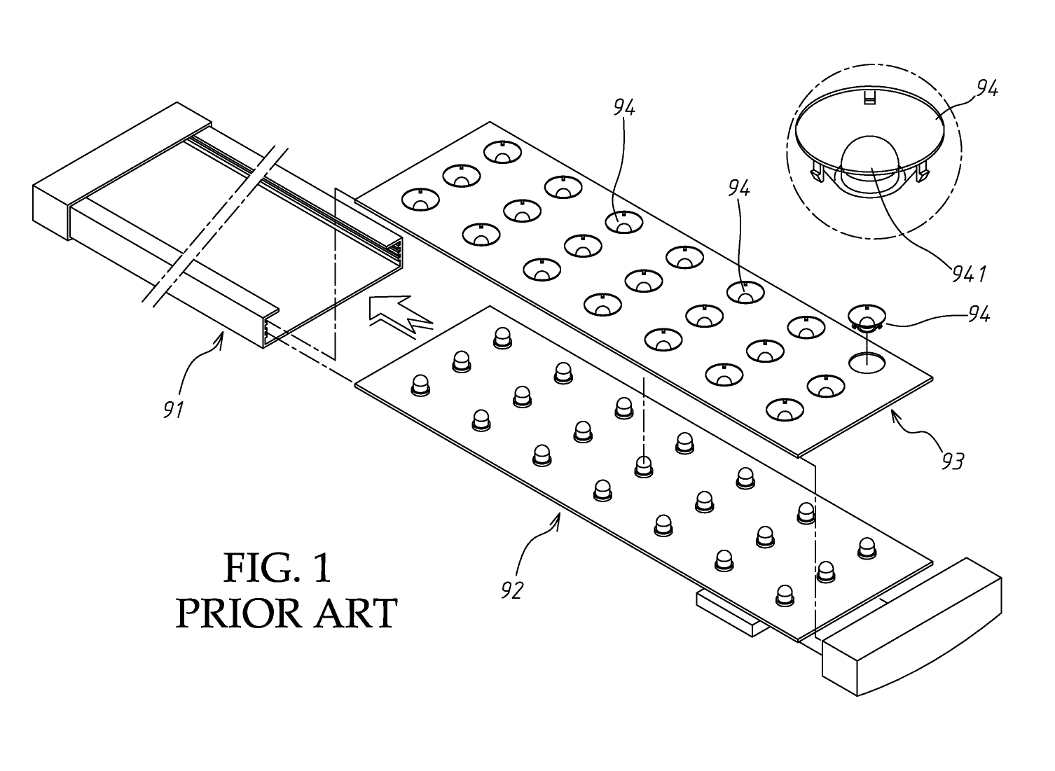

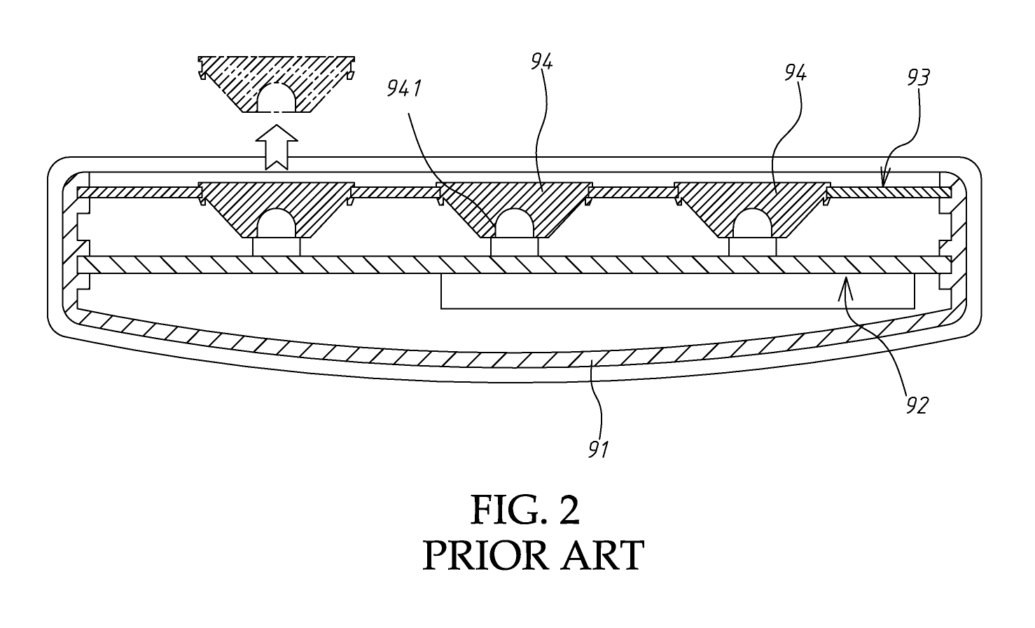

### DETAILED DESCRIPTION OF THE PREFERRED EMBODIMENT

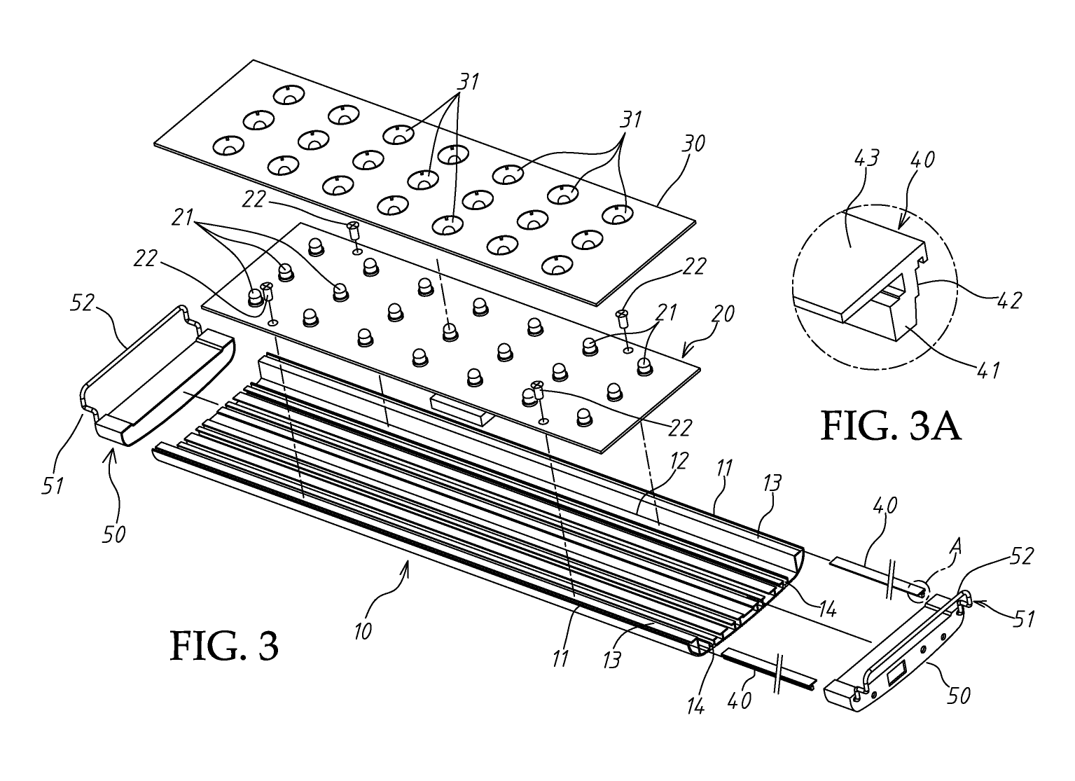

Referring to FIGS. 3-5, an aquarium LED lighting device in accordance with the present invention is shown comprising a casing 10, a LED circuit board 20, a LED cover board 30, two packing strips 40 and two end blocks 50.

The casing 10 is a flat rectangular hollow member, comprising two locating grooves 11 respectively extending along opposing front and rear sides thereof in a parallel manner, a recessed accommodation portion 12 defined between the two locating grooves 11, two elongated horizontal planes 13 respectively extending along the locating grooves 11 at an inner side and at a higher elevation relative to the locating grooves 11, and a plurality of ribs 14 disposed inside the recessed accommodation portion 12 and extending along the length thereof.

The LED circuit board 20 is mounted in the recessed accommodation portion 12 of the casing 10 and affixed to the ribs 14 of the casing 10 by screws 22, comprising a plurality of LEDs (light-emitting diodes) 21 arranged at the front side (light-emitting side) thereof.

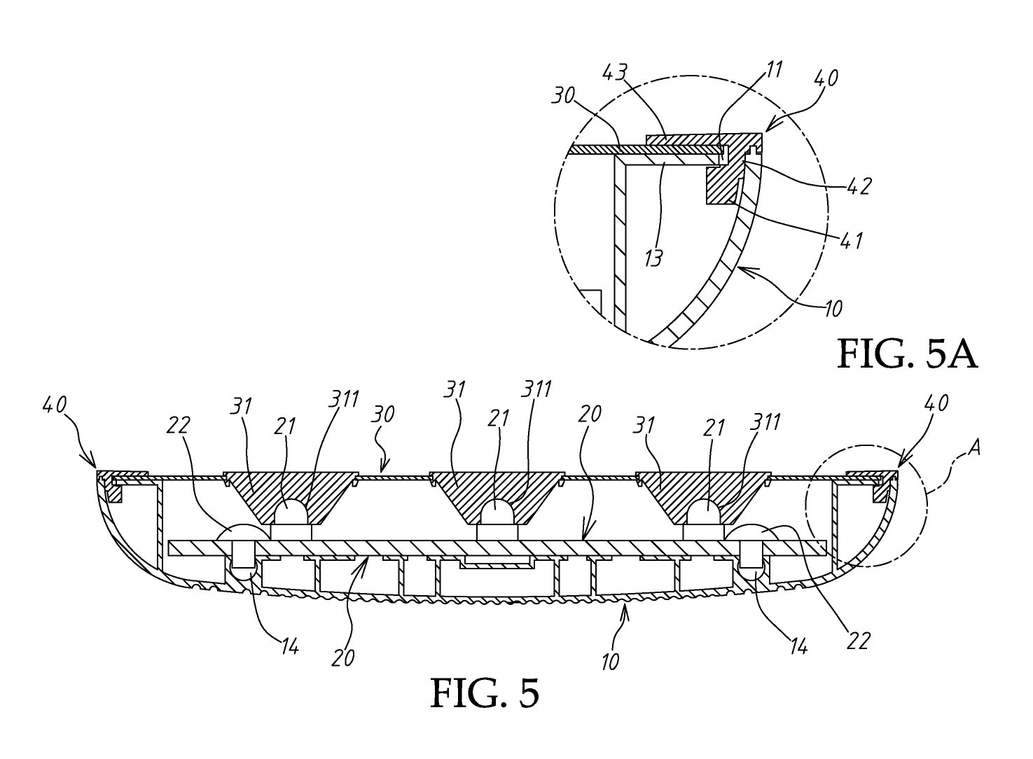

The LED cover board 30 is affixed to the casing 10 and kept in a parallel manner relative to the LED circuit board 20, comprising a plurality of LED caps 31 corresponding to the LEDs 21 of the LED circuit board 20. The LED caps 31 are made of a light-transmissive material in a conical shape and formed integral with the LED cover board 30 for diffusing the light emitted by the LEDs 21, each defining therein a recessed hole 311 for receiving one respective LED 21, as shown in FIG. 5.

The two packing strips 40 are respectively fastened to the locating grooves 11 of the casing 10 to secure the LED cover board 30 to the casing 10. As illustrated in FIG. 3A, each packing strip 40 comprises a protruding tongue 41, a flat horizontal base 43 and a neck portion 42 connected between the protruding tongue 41 and the flat horizontal base 43. The neck portion 42 is engaged into one locating groove 11 of the casing 10. The opposing front and rear edges of the LED cover board 30 are respectively sandwiched in between the flat horizontal bases 43 of the packing strips 40 and the elongated horizontal planes 13 of the casing 10, as shown in FIG. 5A.

The two end blocks 50 are respectively attached to the two distal ends of the casing 10, each comprising a resilient retaining hook wire rod 51 having a curved hanging portion 52 for hanging on an aquarium.

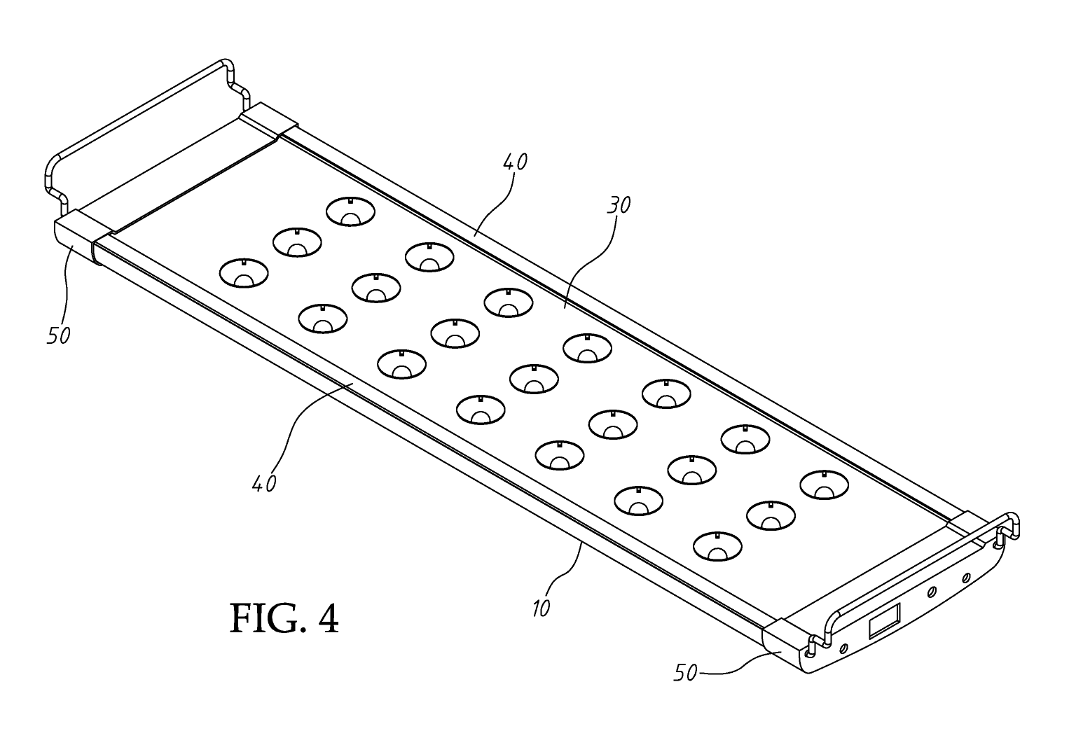

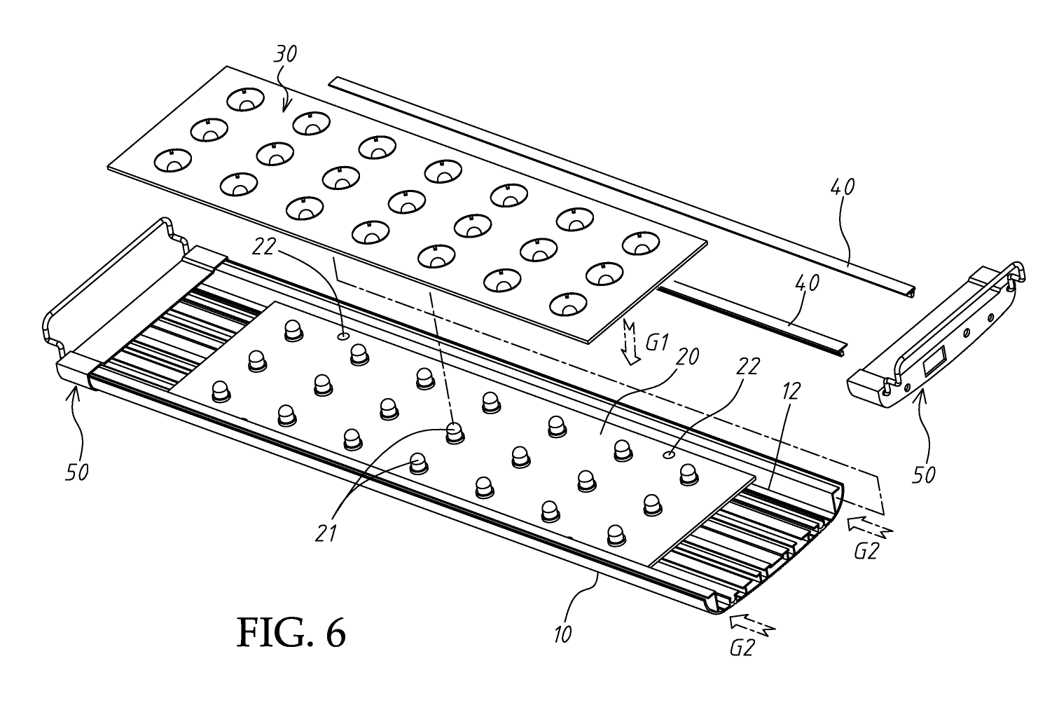

When assembling the aquarium LED lighting device, as shown in FIG. 6, affix the LED circuit board 20 to the ribs 14 in the recessed accommodation portion 12 of the casing 10 by screws 22, and then attach the LED cover board 30 to the recessed accommodation portion 12 of the casing 10 in a vertical direction G1, and then insert the neck portions 42 of the packing strips 40 into the locating grooves 11 of the casing 10 in a horizontal direction G2 to let the opposing front and rear edges of the LED cover board 30 be respectively sandwiched in between the flat horizontal bases 43 of the packing strips 40 and the elongated horizontal planes 13 of the casing 10, and then attach the two end blocks 50 to the casing 10 to close the two distal ends of the casing 10, and thus, the aquarium LED lighting device is assembled, as shown in FIG. 4.

In case any individual LED 21 of the LED circuit board 20 fails, reverse the aforesaid assembling procedure to detach the LED cover board 30 from the casing 10, exposing the LEDs 21 of the LED circuit board 20 for replacement.

Obviously, the invention has advantages over the prior art design as follows:

1. The whole structure is easy to assemble.

2. The whole assembly is easily detachable, facilitating replacement of individual LEDs.

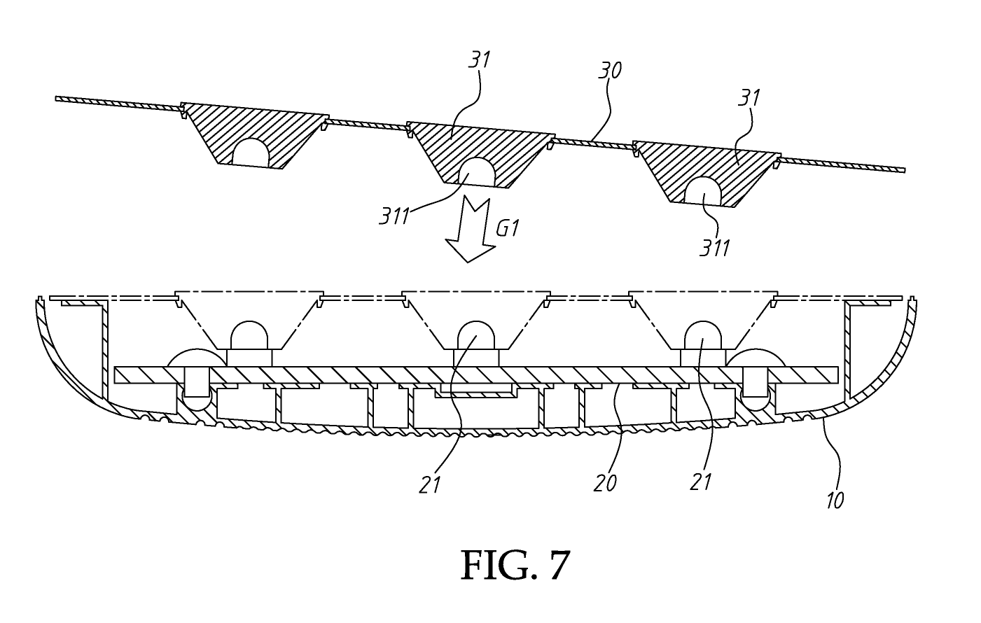

3. During the assembling process, as shown in FIG. 7, the LED cover board 30 is vertically attached to the casing 10 to directly approach the recessed holes 311 of the respective LED caps 31 of the LED cover board 30 to the respective LEDs 21 (see the imaginary line), avoiding accidental image damage.

4. The invention utilizes the conical LED caps 31 to diffuse the light emitted by the LEDs 21, providing uniform illumination and enabling the height of the lighting device to be minimized.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An aquarium LED lighting device, comprising:
a casing comprising two locating grooves respectively extending along opposing front and rear sides thereof in a parallel manner and a recessed accommodation portion defined between said two locating grooves;
a LED circuit board mounted in said recessed accommodation portion of said casing, said LED circuit board comprising a plurality of light-emitting diodes arranged a light-emitting side thereof;
a LED cover board affixed to said casing and kept in a parallel manner relative to said LED circuit board, said LED cover board comprising a plurality of LED caps respectively disposed corresponding to said light-emitting diodes of said LED circuit board and adapted for disusing the light emitted by said light-emitting diodes, each said LED cap defining therein a recessed hole for receiving one said light-emitting diode;
two packing strips respectively fastened to said locating grooves of said casing to secure said LED cover board to said casing; and
two end blocks respectively fastened to said casing to close two distal ends of said casing.

2. The aquarium LED lighting device as claimed in claim 1, wherein said casing further comprises two elongated horizontal planes respectively extending along said locating grooves at an inner side and at a higher elevation relative to said locating grooves; each said packing strip comprises a protruding tongue, a flat horizontal base and a neck portion connected between said protruding tongue and said flat horizontal base, said neck portion being engaged into one said locating groove of said casing; said LED cover board comprises opposing front and rear edges respectively sandwiched in between the flat horizontal bases of said packing strips and the elongated horizontal planes if said casing.

3. The aquarium LED lighting device as claimed in claim 1, wherein each said end block comprises a resilient retaining hook wire rod having a curved hanging portion for hanging on an aquarium.

4. The aquarium LED lighting device as claimed in claim 1, wherein said LED caps of said LED cover board are made of a light-transmissive material in a conical shape.

5. The aquarium LED lighting device as claimed in claim 1, wherein said casing further comprises a plurality of ribs disposed inside said recessed accommodation portion and extending along the length thereof; said LED circuit board is affixed to said ribs of said casing by screw.
